(19) United States
(12) Patent Application Publication
(10) Pub. No.: US 2005/0215329 A1
(43) Pub. Date: Sep. 29, 2005

(54) Bearing of a telescopic connection

(76) Inventors: Matthias Fick, Schnaittach (DE); Jochen Schrok, Lauf (DE); Richard Baier, Herzogenaurach (DE); Norbert Radinger, Nurnberg (DE); Alexander Zernickel, Herzogenaurach (DE)

Correspondence Address: HEDMAN & COSTIGAN P.C., 1185 AVENUE OF THE AMERICAS, NEW YORK, NY, 10036, US

(21) Appl. No.: 11/109,095

(22) Filed: Apr. 19, 2005

Related U.S. Application Data
(63) Continuation of application No. PCT/EP03/11982, filed on Oct. 29, 2003.

(30) Foreign Application Priority Data
Oct. 31, 2002 (DE) 102 50 663.9

(51) Int. Cl. F16D 3/06

(52) U.S. Cl. 464/168

(57) ABSTRACT

A bearing (1, 30) for the longitudinally moveable mounting of an inner profile (2) and of an outer profile (3) on one another, the inner profile (2) and the outer profile (3) being moveable relative to one another along a longitudinal axis (1a, 30a) of the bearing (1, 30), and the bearing (1, 30) transmitting torques between the inner profile (2) and the outer profile (3), and, in the bearing (1, 30), a bearing play directed transversely with respect to the longitudinal axis (1a, 30a) being compensated elastically, with the result that the inner profile (2) and the outer profile (3) are prestressed relative to one another, free of the bearing play, by means of the bearing (1, 30), and, in this case, the profiles (2, 3) moved relative to one another transversely with respect to the longitudinal axis (1a, 30a) and supported on resiliently elastic elements (8) transversely with respect to longitudinal axis (1a, 30a) being freely moveable in relation to one another, at least by the amount of an operating play at the narrowest point between the outer profile (3) and the inner profile (2), and the inner profile (2) and the outer profile (3) being supported relative to one another at an overload safeguard (9) after the operating play has been overcome.

### FIELD OF INVENTION

The invention relates to a bearing for the longitudinally moveable mounting of an inner profile and of an outer profile one on the other, the inner profile and the outer profile being moveable relative to one another along a longitudinal axis of the bearing, and the bearing transmitting torques between the inner profile and the outer profile, the bearing being with
a sheet-metal outer sleeve arranged on the inside in the outer profile and between the outer profile and balls and fixed with respect to the outer profile,
at least one ball guide having orbital ball raceways,
resiliently elastic elements for the compensation of bearing plays, and
an overload safeguard arranged between the outer profile and the inner profile,
   and, at the same time, each of the orbital ball raceways consisting of
a row of balls,
a longitudinal guide having a loaded subset of the balls of the row,
a return guide having a first non-loaded subset of balls of the row, and
two deviations connecting the longitudinal guide to the return guide, the deviations being in each case with a second non-loaded subset of balls of the row,
   the bearing play directed transversely with respect to the longitudinal axis being compensated elastically in the bearing, and, in this case, each of the loaded subsets being loaded in each case by means of at least one of the elements which is sprung elastically by the amount of at least half the bearing play, with the result that the inner profile and the outer profile are prestressed relative to one another by means of the bearing, so as to be free of the bearing play, and, in this case, the profiles, moved relative to one another transversely with respect to the longitudinal axis and supported on the resiliently elastic elements transversely with respect to the longitudinal axis, being freely moveable with respect to one another, at least by the amount of an operating play, at the narrowest point between the outer profile and the inner profile, and the inner profile and the outer profile being supported relative to one another at the overload safeguard after the operating play has been overcome.

### BACKGROUND OF THE INVENTION

The bearing is used preferably for the mounting of two shafts of a steering shaft which are at least pivotable with respect to one another in a telescopic connection longitudinally moveably and jointly with one another, but are preferably rotatable jointly with one another. The mounting is in this case seated between the ends of the shafts, inserted one in the other, of the steering shaft variable telescopically in its length within a predetermined stroke. Steering shafts of this type are connected, for example, to a steering wheel of adjustable position. One of the shafts is in this case assigned fixed to the steering wheel. Furthermore, the mounting is provided elsewhere in the steering shaft in a telescopic connection for compensating the relative movements between the steering gear assigned to the steered axle of the vehicle and the steering wheel fixed to the vehicle.

One of the shafts is in this case inserted with an inner profile in an outer profile on the other shaft in such a way that torques can be transmitted over the entire stroke between the two shafts. Each of the shafts has, at least at the telescopic connection, an outer profile or an inner profile with a cross section which permits an insertion connection between the outer profile and the inner profile. The profiles therefore preferably have cross sections differing from the circular shape.

The bearing satisfies the following requirements in the telescopic connection:
longitudinally moveable mounting of the shafts relative to one another,
protection of the mounting directed transversely with respect to the longitudinal direction and protection of the infinite stroke between the profiles,
rotationally fixed support of the shafts relative to one another,
play-free mounting of the profiles one on the other,
safeguard of the mounting against overload,
adaptation to different profile cross sections not corresponding to one another in the displacement fit.

The shafts are mounted by means of the bearing longitudinally moveably relative to one another along a longitudinal axis of the outer profile. The inner profile moves within the outer profile relative to the outer profile along the longitudinal axis. The quality of the bearing is in this case judged on the basis of the displacement force. The displacement force is a measurable parameter which describes the resistance with which the shafts inserted one in the other can be displaced relative to one another along the longitudinal axis in the mounting. With the aid of the displacement force, statements are made as to the ease of movement in the adjustment of the position of the steering wheel and therefore as to operating comfort. Furthermore, the displacement force serves for assessing the function of length compensation between the two profiles longitudinally moveable one in the other, even during the transmission of the torques as a result, for example, of steering movements.

The displacement force is dependent on the prestress with which the shafts mounted, free of play, one on the other are prestressed relative to one another transversely with respect to the longitudinal axis by means of the bearing. With an increasing prestress, as a rule, the displacement force rises and becomes increasingly dependent on the loads on the bearing. The configuration of the running tracks and the guidance of the rolling bodies in the bearing, together with the prestress in the bearing, directly influence the displacement force.

The displacement force is dependent, further, on the magnitude of the steering moment which acts in the bearing during the telescopic displacements. In this case, with regard to the magnitude of the displacement force, a distinction is to be made between displacement forces occurring at operating moments and displacement forces occurring at moments exceeding the maximum highest operating moment. The term “operating moments” is in this case to be understood as meaning the moments which usually occur under normal circumstances during the adjustment of the steering wheel or during the steering of the vehicle. Moments exceeding the maximum operating moment act on the steering shaft, for example, during steering on difficult terrain or during steering against a kerbstone. The displacement force increases with increasing steering moments on a steering shaft.

Upper limit values are fixed for the displacement force. The influence of the prestress on the displacement force is high particularly in the case of low steering moments on the steering shaft, whereas, in the case of high steering moments, the influence of the steering moment predominates. Relatively low limit values are fixed for the displacement force at operating moments. These values are predetermined by the requirements with regard to the ease of movement with which the steering wheel can be adjusted. Where higher steering moments are concerned, the length compensation in the telescopic connection in the bearing must be protected.

The bearing is constructed according to the principle of a linear bearing of infinite stroke and is assigned fixedly to one of the shafts. Rolling bodies in the form of balls are used, which keep the resistance during the displacement of the shafts in the telescopic connection as low as possible. The bearing is formed at least from an outer sleeve, from a ball guide and from balls. The outer sleeve is pressed into the outer profile or is fastened in the outer profile in another suitable way.

The ball guide is provided with orbital ball raceways. A bearing of the generic type provides a longitudinal guide, a return guide and two deviations for each orbital ball raceway. In each of the orbital ball raceways, in each case a row of balls is guided, the number of which is determined, as a rule, by the requirements as regards the load-bearing capacity of the bearing. A deviation adjoins the longitudinal guide in each of the longitudinal directions of the bearing. The deviation is provided with an arcuate track which connects the track of the longitudinal guide and the track of the return guide to one another.

A loaded subset of the row of balls is held in the longitudinal guide. During a longitudinal movement of the profiles mounted one in the other with respect to one another, the balls of a row run positively through the longitudinal guide one after the other and one behind the other in each of the orbital raceways, since the balls tensioned between the profiles are set in a rolling movement and push in front of them the balls located in the deviation and in the return guide.

The shafts are supported one on the other, on the outer profile and on the inner profile, in all directions transversely with respect to the longitudinal axis via the bearing. The reaction forces to be absorbed in this case by the bearing are relatively low, as compared with the reaction forces in the bearing during the transmission of torques. The bearing in this case takes into account the play compensation, together with the compensation of errors in alignment and of tiltings of the longitudinal axes of the profiles inserted one in the other.

The loaded subset of the balls supports the shafts on one another transversely to the longitudinal axis and relative to one another during steering movements about the axis of rotation. According to the prior art, at least one of the orbital ball raceways is assigned to each of the mutually opposite sides of the outer profile and consequently to each of the mutually opposite sides of the inner profile, so that the inner profile and the outer profile are supported on one another in each direction transversely with respect to the longitudinal axis of the mounting via the respective balls located in the longitudinal guide. The inner profile is centred in the outer profile by means of the bearing.

The return guide and the deviations in the ball guide the non-loaded subsets of the row of balls. After running through the longitudinal guide, the respective balls roll into the deviation lying in the direction of movement. The deviation changes the sense of direction of the movement of the row of balls, so that the balls in the return guide move in the opposite direction to the loaded balls in the longitudinal guide.

The balls positively moved in the longitudinal guide force balls out of the deviation further on into the return guide. The balls move in the return guide, freely and without load, between the outer sleeve and the surface on the inner profile. The free space for the balls which is necessary for this purpose is movement play between the outer sleeve and the balls. The play is an outward clearance between the balls imagined as bearing against the surface of the inner profile and the outer sleeve.

The direction of movement of the balls which continue to be non-loaded, after these leave the return guide, is deflected in a further deviation before renewed entry into the longitudinal guide. After entry into the longitudinal guide, the balls are loaded once again.

The shafts are supported on the outer profile via the bearing fixedly in terms of rotation relative to one another about an axis of rotation, so that torques about the axis of rotation, for example during the steering of the vehicle, can be transmitted between the shafts. The axis of rotation corresponds to a longitudinal axis of the outer profile.

The quality of the bearing is judged on the basis of the torsional strength. The torsional strength is a parameter which describes the degree of elasticity during the rotation of the steering shaft or the resistance to distortion of the steering shaft and is therefore dependent on the torque to be transmitted by the steering shaft and on the angle of rotation over which the steering shaft as a whole is distorted elastically. Elastic springings of the bearing or bearings according to the invention which are kept free of play are the determining variables in the steering shaft, since the surrounding structure of the bearing, in particular the profiles of the shafts, are per se relatively rigid. The angle of rotation is therefore influenced, in particular, by the rigidity of the bearing and consequently by the degree to which the bearing prestresses the shafts relative to one another without a steering moment. The steering shaft system is to be kept so rigid that the shifts, elastic deformations and distortion of the profiles of the steering shaft which occur at the longitudinally moveable mounting of the shafts have no adverse effects on the functioning of the steering and on driving comfort.

The bearing supports the shafts, free of play, on one another and relative to one another in the sliding fit. The lack of driving comfort due to noises of shafts inserted, not free of play, one in the other and due to the subjective sensation of a “spongy steering” and also malfunctions are avoided. For this purpose, the profiles of the steering which are inserted one in the other are prestressed relative to one another, without plays, in all directions transversely to the longitudinal axis by means of the bearing. The degree to which the bearing is prestressed, free of play, is dependent on the sum of the tolerances of the parts built up together in the sliding fit and on the prestress with which the bearing must continue to function, free of play, in the case of low steering moments.

The mounting is to be protected by means of the bearing against deformation and inadmissible deflection under overload due to moments on the steering shaft transversely to the longitudinal axis and about the axis of rotation which exceed the operating moment. For a bearing of the generic type, as a rule, a construction space having only very restricted dimensioning is available. The construction space is predetermined on the inside and on the outside by the dimensions of the profiles between which the bearing is seated. The dimensions of the profiles are kept small for structural and economic reasons. There are therefore already limits placed on the load-bearing capacity of the bearing per se on account of this small construction size. Furthermore, because of the small construction size of the bearing, the elements of the bearing for play-free mounting cannot be subjected to unlimited load.

As a rule, the inner profile seated in the outer profile has, as seen in cross section, in the shape of a polygon, preferably the shape of a polygon with an even number of sides. In each case two of the side faces face away from one another. The outer profile then preferably has a cross section, corresponding to the inner profile, of a polygonally designed hollow profile with preferably an even number of inwardly facing side faces.

A bearing of this type is described in DE 100 62 680 A1. The bearing according to DE 100 62 680 A1 is provided with an elastic sheet-metal intermediate layer, in which are formed the longitudinal guide and the return guide in the form of grooves oriented parallel to the longitudinal axis of the mounting and delimited by the metal sheet. The sheet-metal intermediate layer is assigned to the outer profile, that is to say, as seen from the axis of rotation of the bearing, the intermediate layer is arranged between the balls supported on the surface of the inner profile and the outer profile and is therefore designated further as an outer sleeve.

The loaded subset of the balls of the row are supported inwardly on the surface of the inner profile and outwardly in the groove of the longitudinal guide. The groove-delimiting metal sheet of the outer sleeve is at the distance of a gap dimension from the outer profile and merges into the return guide wall via which the longitudinal guide is supported on the outer profile.

The wall of the outer sleeve is shaped into a groove for the return guide, the depth of which groove corresponds to the diameter of the ball plus the movement play. The movement play is such that, under loads and in this case taking into account all the tolerances in the return guide, the balls are not pinched between the outer sleeve and the inner sleeve or between the outer sleeve and the inner profile. The groove of the return guide preferably runs parallel to the longitudinal guide.

In the bearing, the loaded balls are supported inwardly on the surface of the inner profile and in each case outwardly on the outer sleeve in one of the grooves of the longitudinal guide. The groove-delimiting metal sheet of the outer sleeve is supported on the outer profile via the metal sheet of the return guide. On the side facing away from the loaded balls and facing the outer profile, the outer sleeve is arranged at a free distance from the outer profile by the amount of a gap dimension and in this case prestresses the balls against the inner profile. The balls are prestressed by an amount which ensures that the bearing is play-free after the greatest sum tolerance has been overcome. The gap dimension corresponds at least to the operating play. The operating play protects the compensation of tolerances in the mounting and consequently the functioning of the bearing in the case of operating moments and, as a rule, amounts to a few tenths of a millimetre to a few millimetres.

The prestress on the balls in the longitudinal guide is dependent on the configuration of the groove for the return guide, since the metal sheet of the longitudinal guide is supported on the outer profile via the metal sheet of the return guide. The balls are supported on the outer profile via a lever system predetermined by the walls of the grooves adjacent to one another. The torsional strength of the bearing before block abutment under overload is relatively low because of the great distances in the system and the associated elasticity. Limits are placed on the selection of a thicker metal sheet for the configuration of a more rigid outer sleeve on account of the relatively complicated shape of the latter. The elastic springings over the outer sleeve on the longitudinal guide under load, under some circumstances, have an adverse influence on the geometry of the return guides, so that the balls may possibly be pinched in the return guide.

A deviation adjoins the outer sleeve longitudinally on each of the two sides in a plastic block separate from the outer sleeve. The bearing is protected against overload by means of the deviations longitudinal adjoining the outer sleeve. The bearing first springs elastically under load. After the overshooting of a specific load, which is caused, for example, by an overshooting of the operating moment, the inner profile and the outer profile lie blocked on the deviations. The operating play in the profiles is used up or a residual play remains between the profiles. The longitudinally moveable rolling mounting of the profiles is replaced by a sliding mounting. Sliding tracks are formed by the plastic of the deviation.

### SUMMARY OF THE INVENTION

The object of the invention is to provide a bearing of the generic type which has torsional strength, even in the case of high torques, and, under normal operating conditions, has low wearing forces, and which can be produced simply and cost-effectively.

This object is achieved in that the ball guide is produced as one part with at least one orbital ball raceway, the ball guide being arranged on the inside in the outer profile between the outer sleeve and the inner profile, and in that the safeguard is in each case at least one support which longitudinally adjoins the ball guide, is separate from the ball guide and is directed transversely with respect to the longitudinal axis of the bearing.

The invention is described in more detail below, also with further refinements.

The bearing is formed at least from an outer sleeve or from an outer sleeve and an inner sleeve, from a ball guide separate from the outer sleeve, and from balls. The outer sleeve is pressed into the outer profile, and the inner sleeve is pressed onto the inner profile, or the sleeve or sleeves is or are otherwise fastened in such a way that each sleeve is reliably supported on the respective profile transversely in all directions with respect to the longitudinal axis of the bearing and is secured to the respective profile in the longitudinal directions of the bearing.

The inner profile seated in the outer profile preferably has, as seen in cross section, the shape of a- polygon, preferably the shape of a polygon with an even number of sides. The side faces in each case point outwards. In each case two of the side faces face away from one another. At least the outer sleeve, optionally the outer profile, preferably has a cross section, corresponding to the inner profile, of a polygonally designed hollow profile with preferably an even number of sides. The cross section of the outer sleeve corresponds to the cross sections of the profiles or, for example, is adapted to the outer profile by suitable means, such as by means of an adapter. The outer sleeve has essentially the cross section of a polygonal hollow profile, preferably with an even number of sides. In each case at least one of the orbital ball raceways is assigned to at least four inwardly facing sides of the outer sleeve. In each case two of the four sides lie opposite one another so as to receive the inner profile between them. The longitudinal guide and the return guide of each orbital ball raceway lie next to one another between the outer sleeve surrounding the inner profile circumferentially on the outside and the inner profile. The profiles are supported on one another on each of the four sides via the loaded balls of a longitudinal guide. In a refinement of the invention, two orbital ball raceways lying next to one another are provided for each of the four sides. Accordingly, in the refinement of the invention, the bearing is provided with a ball guide which has eight of the orbital ball raceways.

Each of the orbital ball raceways is, seen as a whole, a self-contained uninterruptedly orbiting track with the longitudinal guide, with the return guide and with the deviations. A row of balls runs, unobstructed, through the track. In the track, the balls are held inwardly in the direction of the inner profile and outwardly in the direction of the outer profile by the material of the ball guide.

There are preferably 18 to 25 balls provided for each orbital ball raceway, preferably each of the orbiting balls of a row covering, in one orbit, a distance which corresponds at least to the sum of the diameters of all the balls of the row plus the diameter of one of the balls from the row.

Each row of the balls is divided into subsets which differ from one another in the type of load. One subset of the row of balls is loaded constantly in the longitudinal guide. On the non-actuated steering shaft, the loads are applied essentially only due to the prestress of the elements for the protection of freedom from play in the bearing. Steering movements and changes in the length of the steering shaft generate supporting forces in the bearing on the loaded subsets. In the deviations and in the return guide, the further subsets of the row are constantly non-loaded, even in the event of overload. In the case of a telescopic change in length of the steering shaft, the balls run through the orbital raceway. During an orbit, the balls of a row are loaded balls in the longitudinal guide, non-loaded balls in one of the deviations, non-loaded balls in the return guide, and, finally, again loaded balls in the longitudinal guide.

The longitudinal guide has a slot-like design, and the slot pierces the wall of the ball guide from the inside outwards and, as seen in the cross section of the bearing, is delimited laterally by walls of the material of the ball guide. The distance between the mutually opposite side walls of the longitudinal guide at the widest point corresponds to the diameter of the balls plus a flank play. A flank play ensures the longitudinally freely moveable guidance of the balls and preferably corresponds to at least 1/10 mm.

The balls are held inwardly and outwardly in the longitudinal guide transversely with respect to the direction of movement of the balls in the longitudinal guide. For this purpose, as seen in the cross section of the bearing, the distance between the mutually opposite walls, starting from the greatest distance, decreases towards the inner and outer edges of the longitudinal guide. The distance between the edges in each case located opposite one another on the inside or on the outside of the ball guide is smaller than the diameter of each of the balls of the orbital ball raceway. The thickness of the wall of the ball guide which, considered in cross section, extends from the inside outwards is, at least on the longitudinal guide, smaller than the diameter of the balls. Thus, at least on the longitudinal guide, the balls located in the longitudinal guide project from the longitudinal guide, beyond the edges, inwards in the direction of the inner profile and outwards in the direction of the outer sleeve. The edges lying opposite one another in each case on the inside and the edges lying opposite one another in each case on the outside receive the balls between them on a ball segment, the diameter of which is smaller than the diameter of the ball, and hold the ball in the longitudinal guide.

In each case one of the deviations, as a further part of the track, adjoins the longitudinal guide longitudinally, in such a way that the longitudinal guide of slot-like design merges into the arcuately running deviation. By means of the material of the ball guide, each of the deviations is at least partially closed off or opened inwardly towards the inner profile and is opened outwardly towards the outer profile. The distance between the mutually opposite sidewalls of the deviation at the widest point corresponds to the diameter of the balls plus a flank play. A flank play ensures the freely moveable guidance of the balls in the deviation and corresponds at least to 1/10mm. The balls are held in the deviation, outwardly towards the outer profile, by the edges of the deviation. The edges delimit the deviation outwardly on both sidewalls of the deviation. At least one edge on one side of the deviation projects in the manner of an overhang over the outwardly open deviation. The distance between the mutually opposite sidewalls at the narrowest point, level with the overhang, is smaller than the ball diameter of each ball of the row in the orbital ball raceway. Alternatively, in a similar way to the configuration of the longitudinal guide, the distance is determined by the mutually opposite edges.

The deviations merge into the return guide. The return guide either is closed off inwardly towards the inner profile and opened outwardly towards the outer profile by means of the material of the ball guide or has a slot-like design and is therefore open in both directions. The balls are held in the return guide, outwardly towards the outer profile, by the edges of the return guide. The distance between the mutually opposite sidewalls of the return guide at the widest point corresponds to the diameter of the walls plus a flank play. The flank play ensures the freely moveable guidance of the balls in the return guide and corresponds to at least 1/10 mm. The distance between the mutually opposite sidewalls at the narrowest point is smaller than the ball diameter of each ball of the row in the return guide and is determined by the distance between the mutually opposite edges. The mutually opposite edges receive the balls between them on a ball segment, the diameter of which is smaller than the diameter of the ball, and holds the ball in the return guide. The edges delimit the return guide inwardly and/or outwardly on both sidewalls of the return guide in a similar way to the configuration of the longitudinal guide. Alternatively to this, at least one edge on one side of the return guide projects in the manner of an overhang over the outwardly open groove of the return guide.

The ball guide is premounted as a subassembly or as a plurality of subassemblies, the subassembly or subassemblies being formed from at least one ball guide with balls. The balls of a row are snapped into the orbital ball raceway, the track, during mounting, briefly being positively widened elastically at the edges to the diameter of the balls as a result of the snapping-in of the balls.

The ball guide is a component which is produced preferably from plastic, alternatively also from metal. The material provided is, for example, plastic bearing the designation of polyoxymethylene (brief designation POM). The ball guide is preferably a hollow profile of essentially rectangular cross section which has a circumferentially closed design and is open in both longitudinal directions and in the wall of which the orbital ball raceways are formed. Alternatively to this, however, the ball guide is produced as one part, slotted in the longitudinal direction, or is formed, multi-part, from at least two to four individual parts, each of the individual parts having at least one of the orbital ball raceways with a row of balls.

That subset in each row of balls of the orbital ball raceways which is under load in the longitudinal guide is supported outwardly on an inwardly pointing inner face portion of the inner face of the outer sleeve, the said face portion running in the longitudinal direction over the longitudinal guide. During longitudinal movements of the shafts in the mounting, the loaded balls roll on the inner face portion in the longitudinal direction of the bearing. The load-bearing capacity of the bearing is dependent on the number of balls in the longitudinal guide and on the diameter of these balls. A higher load-bearing capacity is in this case achieved expediently by means of a larger number of balls.

The load-bearing capacity of a bearing according to the invention is further increased when the outer sleeve is provided at least with a running groove on the inner face portion. The running groove is designed to be recessed outwardly on the outer sleeve and runs longitudinally codirectionally with the longitudinal guide in such a way that that subset of the row of balls which is guided in the longitudinal guide rolls in the running groove in the event of a telescopic movement. In a bearing which has only an outer sleeve and no inner sleeve, the loaded balls of a row are supported inwardly directly on the surface of the inner profile.

In a bearing which has both an outer sleeve and an inner sleeve, the loaded balls are supported inwardly on an outwardly pointing outer face portion on the outer face of the inner sleeve. The loaded subset of a row is simultaneously supported outwardly, as already described. Alternatively, the face portions are provided with running grooves. The inner face portion with or without a running groove and the outer face portion with or without a running groove are opposite one another. The longitudinal guide runs longitudinally between the face portions or running grooves codirectionally with the portions or grooves. The plane face portions or the running grooves in this case extend in the longitudinal direction at least over the entire length of the longitudinal guide.

Both the running grooves on the inside and the running grooves on the outside are provided with one or more contact zones (for example, for a two-point support of each of the loaded balls in the running groove) and alternatively have additionally an osculation which is customary in rolling bearing technology. Contact pressure in the contact zone between ball and outer sleeve is improved.

The balls of the non-loaded subsets of each of the orbital ball raceways move in the return guide freely, by the amount of the movement play, between the outer sleeve and between the ball-guide material, which lies between the non-loaded subset and the inner profile, or freely, by the amount of the movement play, between the outer sleeve and the inner profile. The free space for the balls which is necessary for this purpose is provided in the outer sleeve. The inner face of the outer sleeve is set back outwards away from the respective subset of balls longitudinally and transversely over the entire return guide and longitudinal and transversely over the deviations. The inner face of the outer sleeve is set back in this region over the longitudinal guide on the outer sleeve, in comparison with the load-bearing inner face portion, at least to an extent such that a movement play remains from the inside outwards between the balls imagined as bearing against the material or against the inner profile and the outer sleeve. The movement play ensures the longitudinally freely moveable guidance of the non-loaded subset and is preferably greater than the operating play. The distance over which the inner face of the outer sleeve is set back over the return guide from the inside outwards, starting from the inner face portion, corresponds alternatively at least to the thickness of the material of the return guide between the balls and the inner profile plus the movement play or to the movement play. This distance is in both cases such that, in all the presupposed operating states, and taking into account all the tolerances in the return guide, the balls are not pinched between the outer sleeve and the ball guide.

The wall of the outer sleeve has, for example, a longitudinal groove which is recessed from the inside outwards and which extends longitudinally and transversely over the return guide and selectively also over the deviations. The depth of the longitudinal groove then corresponds at least to the movement play. Alternatively, the outer sleeve is provided outwardly with a shaped-out portion of the wall of the return guide and selectively over the deviations. This shaped-out portion of the outer sleeve in this case projects, at least over the return guide and over the deviations, out of the contour of the outer sleeve which is provided per se, at least on the outside, with a polygonal or square cross section. The inner face of the shaped-out portion is set back with respect to the inner face portion from the inside outwards by the amount of at least the movement play.

One of the longitudinal grooves or one of the shaped-out portions on the outer sleeve is assigned to each of the orbital raceways of the ball guide on the outside over the return guide and over the orbital raceways. Alternatively to this, one of the longitudinal grooves or one of the shaped-out portions spans, transversely to the longitudinal direction, two mutually adjacent return guides of two mutually adjacent orbital ball raceways of a ball guide. In each case two of the adjacent orbital ball raceways are jointly assigned in each case to one of the four inwardly facing sides of the outer sleeve. In this case, the longitudinal guides of the adjacent orbital ball raceways lie directly next to one another in one plane between the outer sleeve and the inner profile. Alternatively to this, the orbital ball raceways are adjacent to one another on the circumference of the inner profile. Thus, in each case one of the orbital ball raceways is assigned in each case to one of two sides, circumferentially adjacent to one another, of the four sides of the outer sleeve. The adjacent return guides lie in two planes which preferably form between them a right angle, but also an angle greater than 90°.

The resilient elastic elements are spring plates produced in one part with the outer sleeve or in one part with the inner sleeve and consisting of the sheet metal on the respective sleeve. In each case one of the spring plates is prestressed against a subset of the row of balls in one of the longitudinal guides. Each of the mutually opposite sides of the outer sleeve or inner sleeve has at least one of the spring plates, so that the inner profile and the outer profile are prestressed, free of play, relative to one another.

The outer sleeve is provided on each of the mutually opposite sides with at least one longitudinal slot which is codirectional with the longitudinal direction of the bearing. The spring plate extends longitudinally in the form of a strip along the longitudinal slot. The spring plate is delimited transversely to the longitudinal direction by cross slots in the outer sleeve which run at right angles to the longitudinal slot and which merge in each case to the longitudinal slot. Each of the spring plates thus emanates in a lever-like manner from the outer sleeve transversely to the longitudinal axis at the start of the cross slots. In this case, the spring plate at least partially either projects outwards beyond the contour of the outer sleeve or projects into the interior of the outer sleeve.

On the inwardly facing face of the spring plate is formed the inner face portion against which the balls located in the longitudinal guide bear or on which the balls guided in the longitudinal guide roll. A gap remains between the outwardly facing side of the spring plate and the outer profile. The gap is at least of a size such that, during the mounting of the ball guide and of the inner profile into the outer sleeve and in the event of loads on the bearing, the spring plate can be deflected freely outwards, without coming to bear against the outer sleeve. During the mounting of the ball guide together with the outer sleeve, the mutually opposite spring plates spring outwards elastically by the amount of a prestressing dimension and thereafter bear, prestressed, with the face portion in each case against a subset of balls which is thus loaded. In this case, as seen in a cross section of the bearing, each of the spring plates spans the subset on the outside transversely to the longitudinal guide.

Alternatively, the inner sleeve is provided, on each of the sides pointing away from one another with at least one longitudinal slot which is codirectional with the longitudinal direction of the bearing. The spring plate extends longitudinally in the form of a strip along the longitudinal slot. The spring plate is delimited transversely to the longitudinal direction by cross slots in the inner sleeve which run at right angles to the longitudinal slot and which merge into the longitudinal slot. Each of the spring plates thus emanates in a lever-like manner from the inner sleeve transversely to the longitudinal axis at the start of the cross slots. In this case, the spring plate projects at least partially outwards beyond the contour of the outwardly facing sides of the inner sleeve. A gap remains between the inwardly facing side of the spring plate and the inner profile. The gap is at least of a size such that, during the mounting of the ball guide and of the inner profile into the outer sleeve and in the event of loads on the bearing, the spring plate can be deflected freely inwards, without coming to bear against the inner profile. On the outwardly facing side of the spring plate is formed the inner face portion against which the balls located in the longitudinal guide bear or on which the balls guided in the longitudinal guide roll. During the mounting of the ball guide together with the inner sleeve and with the outer sleeve, the spring plates pointing away from one another spring inwards elastically by the amount of the prestressing dimension and thereafter bear, prestressed, with a face portion in each case on a subset of balls which is thus loaded.

The degree of prestressing of each spring plate is dependent, on the one hand, essentially on the lever length with which the balls oriented longitudinally one behind the other are spaced apart in the longitudinal guide transversely to the start of the cross slots. On the other hand, the degree of prestressing is dependent on the cross sections of the lever of the spring plate. The prestress decreases with an increasing lever length and/or with a decreasing cross section of the spring plate.

The balls of the non-loaded subsets of each of the orbital ball raceways move in the deviation either, as mentioned at the outset, below the groove or the longitudinal guide freely between the outer sleeve and between the ball-guide material which lies between the non-loaded subset and the inner profile. Alternatively to this, in a refinement of the invention, there is provision for the necessary free space for the balls to be provided at the spring plates of the outer sleeve. The spring plates in this case cover at least part of the deviation from the outside longitudinally and transversely and are set back outwards away from the respective subset of balls longitudinally and transversely over the deviations. The spring plates are in this case set back, in comparison with the inner face portion, starting from the run of the balls out of the longitudinal guide into the deviation, to an extent such that sufficient play remains from the inside outwards between the balls imagined as bearing against the material of the ball guide or against the inner profile and the spring plate.

The bearing according to the invention is designed in such a way that profiles are mounted elastically flexibly on the spring plates via the balls up to the action of the highest operating moment. When the upper limit of the operating torque is overshot, the bearing springs in. The profiles bear “blocked” against the overload safeguard lying between the profiles. After the overshooting of the highest operating moment, the balls, the face portions and the spring plates of the bearing are free of further higher loads. The safeguard according to the invention is in each case at least one support between the inner profile and the outer profile, which support adjoins the ball guide longitudinally, is separate from the ball guide and is directed transversely with respect to the longitudinal axis of the bearing. The support is preferably formed from sheet metal.

According to a refinement of the invention, the support is at least one perforated disc which, in a bearing without an inner sleeve or in a bearing with an inner sleeve, surrounds the inner profile circumferentially and is surrounded by the outer sleeve. The perforated disc has on the outside and on the inside an inner and an outer contour corresponding to a respective profile. At least one gap at least of the size of the operating play remains on each side, transversely to the longitudinal axis of the bearing, between the perforated disc and between the side faces of the inner profile which face away from one another or between the perforated disc and between the mutually opposite sides of the outer sleeve. After the operating play has been overcome by the profiles moved relative to one another under load, these bear “blocked” against the perforated disc on the inside and on the outside.

One of the perforated discs is or, alternatively, two of the perforated discs are provided as a safeguard against overload in the bearing. Two of the discs receive the ball guide longitudinally between them and are fastened alternatively to the outer sleeve or to the inner profile, for example by means of a press fit.

According to a further refinement of the invention, the support is produced in one part with the outer sleeve and is at least one rim of the outer sleeve, said rim projecting from the outer sleeve inwardly in the direction of the inner profile. At least the gap which corresponds at least to the operating play remains, transversely to the longitudinal axis of the bearing, between the rim and between the side faces of the inner profile which face away from one another. The outer sleeve is alternatively provided with two of the rims which receive the ball guide between them in the longitudinal direction.

In a further refinement of the invention, the support is formed in each case from at least one sheet-metal strip emanating from each of the sides of the inner sleeve outwards in the direction of the outer profile and in one part with the inner sleeve. At least the gap which corresponds at least to the operating play remains, transversely to the longitudinal axis of the bearing, between the sheet-metal strip and between the side faces of the outer profile which face one another. Alternatively, the inner sleeve is provided, on each of its longitudinal sides, with the sheet-metal strips which receive the ball guide between them in the longitudinal direction. After the operating play has been overcome, the outer sleeve or the outer profile bears against the sheet-metal strip and consequently against the inner sleeve and is thus supported directly on the inner sleeve.

The operating play takes into account the bearing play in all the cases mentioned previously, so that the operating play between the inner profile and outer profile on each side corresponds to at least half the largest sum of all the tolerances to be compensated by means of the resilient elastic elements, plus at least 1/10 mm.

The mounting is preferably used between the polygonal profiles described at the outset and, alternatively, between cylindrically designed profiles, thus resulting in refinements of the invention which are described below:
a.) The bearing is seated between the outer profile and the inner profile. The bearing is formed from an outer sleeve, from balls and from a ball guide. The outer sleeve of the bearing is provided on the inside and on the outside with a cross section differing from the circular shape, is seated between the outer profile and the inner profile and in this case surrounds the inner profile circumferentially. The outer sleeve is in this case supported in the outer profile and is held immovably longitudinally, so that the outer sleeve cannot be rotated about the axis of rotation with respect to the outer profile. The outer sleeve has at least four inner faces, of which in each case two of the inner faces lie opposite one another according to the function of the bearing. Preferably, the outer sleeve is, in cross section, essentially a square profile with rounded corners.

The cross section of the inner profile inserted in the outer profile corresponds essentially to the cross section of the outer sleeve. An outer face of the inner profile lies, on the inside, opposite each of the inner faces on the outer sleeve. The inner profile consequently has at least on the outside, like the outer sleeve, a cross section which differs from the circular shape. Preferably, the inner profile on the shaft is a profile which is hollow or is filled completely with material and which, in cross section, has an essentially rectangular configuration on the outside with rounded corners. The balls are arranged between the outer sleeve and the inner profile, so that the shafts are supported on the outer profile, via the outer sleeve and also via the balls and via the surface of the inner profile, transversely to the longitudinal axis, on one another and relative to one another so as to be non-rotatable about the axis of rotation with respect to one another.
b.) The bearing is seated between the outer profile and the inner profile. The bearing is formed from an inner sleeve, from an outer sleeve, from balls and from a ball guide. The outer sleeve is configured in a similar way to the variant a.).

The inner sleeve of the bearing is provided with a cross section differing on the inside and on the outside from the circular shape and adapted essentially to the inner shape of the outer sleeve, is seated between the outer sleeve and the inner profile and in this case surrounds the inner profile circumferentially. The inner sleeve is in this case supported on the inner profile, so that the inner sleeve cannot be rotated about the axis of rotation with respect to the inner profile. Moreover, the inner sleeve is held immovably longitudinally on the inner profile.

The balls are arranged between the inner sleeve and the outer sleeve, so that the shafts are supported on the outer profile, via the inner sleeve, via the balls and via the outer sleeve, transversely to the longitudinal axis, on one another and relative to one another so as to be non-rotatable about the axis of rotation and with respect to one another.

The bearing according to variant a.) or b.) is used between the shafts, the profiles of which have alternatively at least cross sections according to the following variants:
c.) The outer profile on one of the shafts mounted on one another has, at least on the inside, a cross section corresponding to the circular shape or a cross section not corresponding to the outer sleeve. The fit of the outer sleeve in the outer profile is protected, for example, by means of an adapter. Alternatively to this, the outer sleeve is held in the outer profile non-rotatably about the axis of rotation and longitudinally fixedly via suitable fastening and/or supporting elements produced selectively in one part with the outer sleeve or separately from the outer sleeve or by means of a suitable outer contour.
d.) The outer profile, has, on the inside, a cross section which differs from the circular shape and which is determined by the contours of four inner faces. In each case two of the inner faces lie opposite and facing one another. The cross section of the outer sleeve is essentially adapted on the outside to the cross section of the outer profile on the inside. The outer sleeve is guided or fastened closely in the outer profile, so that the outer sleeve, on account of its cross section corresponding to the outer profile, cannot be rotated about the axis of rotation with respect to the outer profile.
e.) The inner profile of the shaft inserted in the outer profile has, at least on the outside, a cross section corresponding to the circular shape or a cross section not corresponding to the outer sleeve or to the outer profile. The fit of the inner sleeve on the inner profile is protected, for example, by means of an adapter. Alternatively to this, the inner sleeve is held on the inner profile non-rotatably about the axis of rotation and longitudinally fixedly via suitable fastening and/or supporting elements produced selectively in one part with the inner sleeve or separately from the inner sleeve or by means of a suitable inner contour. The inner sleeve has the four outer faces on the outside. One of the outer faces on the inner sleeve lies opposite each of the inner faces on the outer sleeve.
f.) The cross section of the inner profile inserted in the outer profile corresponds essentially to the cross section of the outer sleeve. An outer face of the inner profile lies, on the inside, opposite each of the inner faces on the outer sleeve. The inner profile consequently has at least on the outside, like the outer sleeve, a cross section which differs from the circular shape. Preferably, the inner profile is a profile which is hollow or is filled completely with material and, in cross section, has an essentially rectangular configuration on the outside with rounded corners. The inner sleeve of the bearing is provided with a cross section differing from the circular shape on the inside and on the outside and essentially adapted to the inner shape of the outer sleeve and to the outer shaper of the inner profile, is seated between the outer sleeve and the inner profile and in this case closely surrounds the inner profile circumferentially. The inner sleeve is in this case supported on the inner profile or bears closely against the latter, so that the inner sleeve, on account of its cross section corresponding to the inner profile, cannot be rotated about the axis of rotation with respect to the inner profile.

Preferably, the bearing is inserted on the outside onto an inner profile and on the inside into an outer profile, said profiles having the above-described cross section differing from the circular shape, since the outlay in terms of the production of the bearing is low. The use of adapters, however, is not to be ruled out in applications where the inner profile and/or the outer profile on the respective shaft is of cylindrical or hollow-cylindrical design or where the profiles have cross sections differing from one another and other cross sections not corresponding to one another for the transmission of torques. An adapter is preferably manufactured from plastic and is cast, injection-moulded, pressed or snapped into the outer profile or the inner sleeve or is snapped, pressed or injection-moulded on the inner profile or the outer sleeve. Alternatively, the plastic of the adapter is cast around the inner profile or the outer sleeve. The adapter and connection are to have as rigid a design as possible, so that, at the longitudinally displaceable connection, the shifts of the shafts inserted one into the other relative to one another along, transversely with respect to and about the longitudinal axis or axis of rotation of the adapter and its connection are kept as low as possible.

Bearings without inner sleeves have a relatively small construction height and therefore take up less construction space. They are preferably used in steering shafts having small cross sections and are cost-effective to produce. Since the balls run directly on the surface of the inner profile of a shaft, the surface of the inner profile must, at least in terms of hardness and roughness, conform to the requirements to be satisfied by a linear bearing for this purpose. The inner profile is therefore, if appropriate, hardened at least on the surface and, for example, machined on the surface by grinding. This machining of the inner profile is dispensed with when an inner sleeve is used in the bearing. The inner sleeve, like the outer sleeve, is preferably cold-formed. The surface, consolidated and equalized by the cold-forming, on the inner and the outer running tracks has a roughness which satisfies the requirements with regard to a linear bearing for this purpose. The sheet-metal parts are alternatively hardened on the surface or through-hardened. The outer sleeve and the inner sleeve are preferably produced from cold-formable sheet steel which is selectively surface-hardenable or through-hardenable. The perforated disc is preferably produced from punchable sheet metal, for example from sheet steel, and is selectively hardenable.

The length compensation in the mounting by means of a bearing according to the invention is ensured even in the case of high steering moments on the steering wheel. Warpings and therefore, under certain circumstances, destructions as a result of a non-functioning length compensation on the steering or in the bearing are avoided. The mounting according to the invention has ease of movement, so that, for example, in the case of a steering moment of 20 Nm on the steering wheel, a displacement force of 50 N is not overshot. As a rule, the position of the steering wheel is varied in a standing vehicle, so that the displacement force in this case lies well below the value of 50 N.

The torsional strength of the bearing according to the invention is, for example up to a torque of 20 Nm, equal to or greater than 50 Nm per degree of angle. Thus, the profiles of the steering shaft which are inserted one in the other rotate about the axis of rotation with respect to one another by the amount of 1/10° for each rise in the operating torque by 5 Nm. In the bearing according to the abovementioned exemplary embodiment, the elastically springing fraction in the event of torques higher than approximately 20 Nm is replaced in the bearing, for example, by the safeguard of the bearing against overload.

### BRIEF DESCRIPTION OF THE DRAWINGS

The invention is explained in more detail below with reference to exemplary embodiments. In the drawings:

FIG. 1 shows a cross section through a bearing according to the invention,

FIG. 2 shows a longitudinal section through the bearing according to FIG. 1,

FIG. 3 shows an outer sleeve of the bearing according to FIG. 1 as an individual part,

FIG. 4 shows a structural unit consisting of inner sleeve and ball guide of the bearing according to FIG. 1,

FIG. 5 shows an exemplary embodiment of an inner sleeve of the bearing according to FIG. 1,

FIG. 6 shows the inner sleeve according to FIG. 5 on an inner profile,

FIG. 7 shows a non-sectional view of the bearing from FIG. 1 from the front,

FIG. 7a shows the detail U of FIG. 7,

FIG. 8 shows a further exemplary embodiment of a bearing according to the invention,

FIG. 9 shows a cross section through the bearing according to FIG. 8,

FIG. 10 shows a longitudinal section through the bearing according to FIG. 8,

FIG. 11 shows an outer sleeve of the bearing according to FIG. 8 in longitudinal section,

FIG. 12 shows the detail Z from FIG. 11,

FIG. 13 shows a non-sectional view of the bearing according to FIG. 8 from the front,

FIG. 14 shows a perforated disc from the bearing according to FIG. 8,

FIG. 15 shows an exemplary embodiment of a ball guide capable of being used in the bearings according to FIG. 1 and FIG. 8,

FIG. 16 shows a section through the deviation of the ball guide according to FIG. 15 in a section along the line XVI-XVI, and

FIG. 17 shows a section through the longitudinal guide of the ball guide from FIG. 15 in a section along the line XVII-XVII.

### DETAILED DESCRIPTION OF THE DRAWINGS

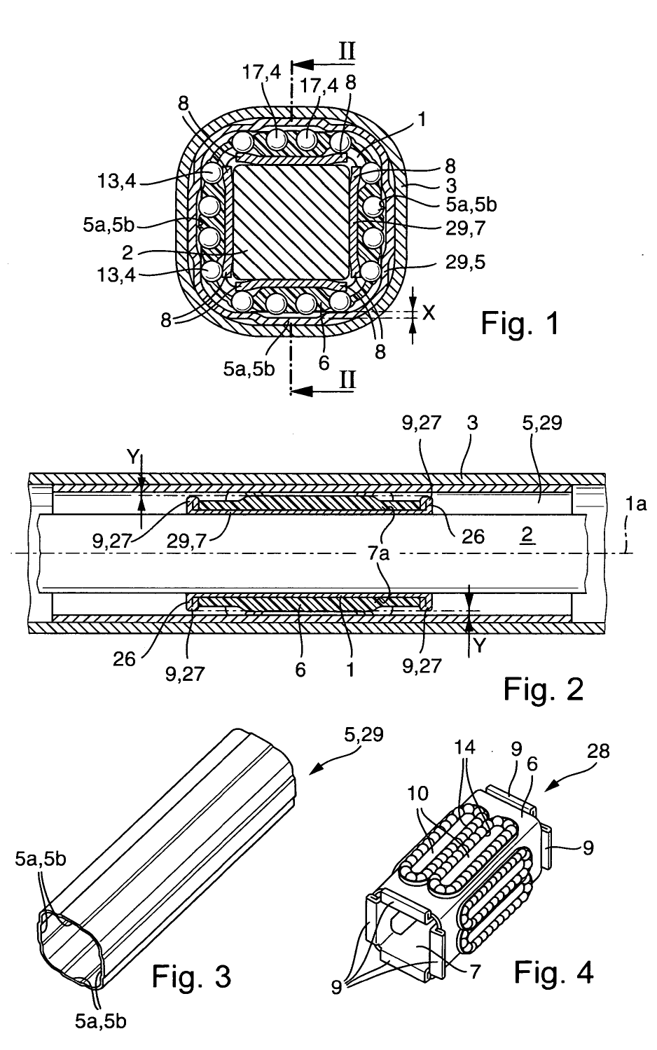

FIGS. 1 to 7 show an exemplary embodiment of a bearing 1 according to the invention in various views and also various individual parts of the bearing 1. FIG. 1 illustrates a cross section and FIG. 2 a longitudinal section through the bearing 1 between an inner profile 2 and an outer profile 3. The bearing 1 serves the longitudinally moveable mounting of the inner profile 2 and of the outer profile 3 on one another. The inner profile 2 and the outer profile 3 are moveable relative to one another along a longitudinal axis la of the bearing 1. Torques can be transmitted between the profiles 2 and 3 by means of a bearing 1. The bearing 1 consists of a sleeve 29 in the form of an outer sleeve 5, of a ball guide 6 and of a further sleeve 29 in the form of an inner sleeve 7. Furthermore, the bearing 1 has resiliently elastic elements 8 for compensating a bearing play in the bearing 1 and overload safeguards 9.

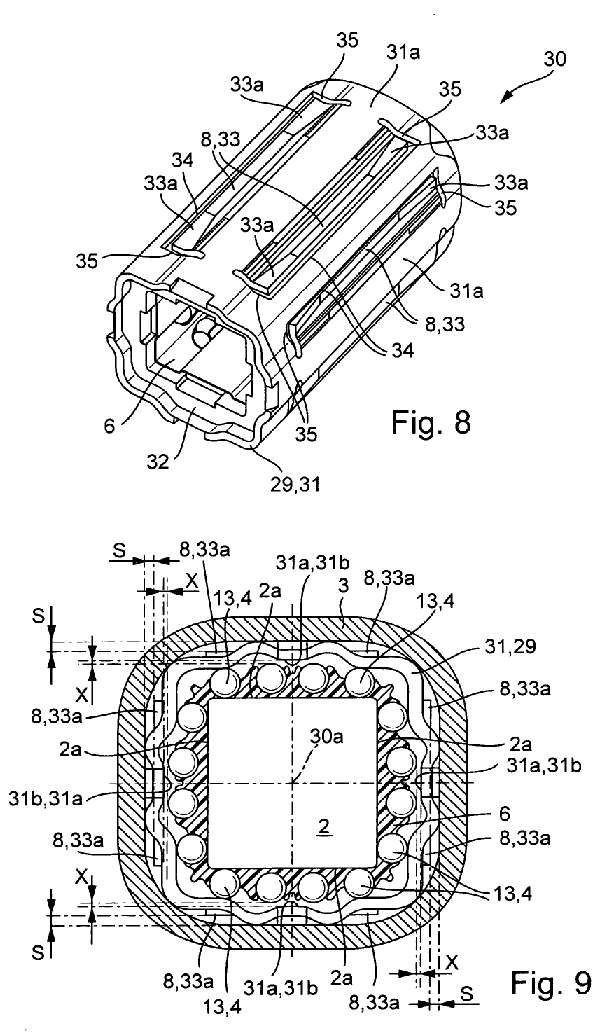

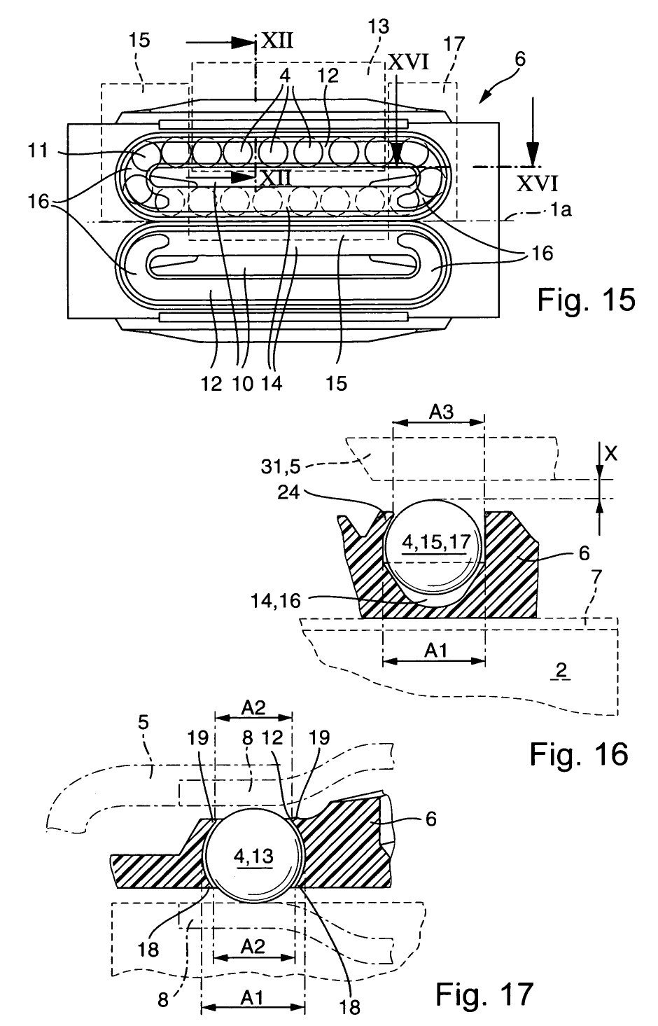

FIGS. 15 to 17 illustrate a ball guide 6 as an individual part, sometimes with balls 4, and in various sections, which ball guide can be used, in terms of its features, both in the bearing 1 according to FIG. 1 and in the bearing 30 according to FIG. 8. The ball guide 6 is produced in one part with orbital ball raceways 10 and is arranged in the bearing 1, in the outer profile 3 on the inside, between the outer sleeve 5 and the inner profile 2. The ball guide 6 is designed as a four-sided hollow profile and has two of the orbital ball raceways 10 on each side. A row 11 having the balls 4 of identical diameter orbits in each orbital ball raceway 10 in the event of telescopic movements of the inner profile 2 with respect to the outer profile 3.

An orbital ball raceway 10 is illustrated, filled with balls 4, in FIG. 15. The orbital ball raceway 10 consists of a longitudinal guide 12, of two deviations 16 and of a return guide 14. During a telescopic movement, a loaded subset 13 runs through the longitudinal guide 12. The balls 4 subsequently move one after the other into one of the deviations 16. A second non-loaded subset 17 of the row 11 runs through the deviation 16, is subsequently lined up into a first non-loaded subset 15 in the return guide 14 and then lined up into the non-loaded subset 17 of a further deviation 16 and is finally guided back into the longitudinal guide 12. The subsets 13, 15, 17 are in each case framed by a broken line in FIG. 15. The longitudinal guide 12 and the return guide 14 run parallel to one another and are oriented parallel to the longitudinal axis 1a. The deviations 16 run arcuately and connect the longitudinal guide 12 to the return guide 14. The balls 4 in each of the rows 11 are held, inwardly in the direction of the inner profile 2 and outwardly in the direction of the outer profile 3, in each case in an orbital ball raceway 10 by means of the material of the ball guide 6.

The longitudinal guide 12 is of slot-like design (FIG. 17). For this purpose, the ball guide 6 is pierced transversely with respect to the longitudinal axis la from the inside, from the direction of the inner profile 2, outwards in the direction of the outer sleeve 5 and, as seen in the cross section through the bearing 1 according to FIG. 1 or FIG. 12, is delimited laterally by the material of the ball guide 6. The greatest free distance A1 between the material of the ball guide in the longitudinal guide 12 corresponds, transversely with respect to the longitudinal axis 1a, to at least the ball diameter of each individual ball 4 in the row 11, plus a flank play between the balls 4 and the walls of the longitudinal guide 13 of approximately 3/10 mm. The balls 4 of the loaded subset 13 are held in the longitudinal guide 12 inwards in the direction of the inner profile 2 as mutually opposite edges 18 of the longitudinal guide 12 and outwards in the direction of the outer profile 3 at mutually opposite edges 19. For this purpose, the greatest distance A1 between the side walls decreases to the distance A2 towards the inner and outer edges 18 and 19. The distance A2 between the mutually opposite edges 18 and 19 is smaller than the diameter of each of the balls 4 of the row 11. Furthermore, the balls 4 of the loaded subset 13 project inwards and outwards beyond the ball guide 6 on the longitudinal guide 12.

Each of the deviations 16 runs at least partially arcuately, is at least partially of slot-like design and is in this case at least partially open inwards towards the inner profile 2 and outwards towards the outer sleeve 5. The balls 4 of the second non-loaded subset 17 in each of the deviations 16 are held inwardly towards the inner profile 2 and outwardly towards the outer profile 3 in a similar way to the balls of the loaded subset 11 (FIG. 17) or in a similar way to the balls of the first non-loaded subset 15 in the return guide 14 (FIG. 16).

The return guide 14 has a groove-shaped design and is in this case closed off (FIG. 16) completely inwardly towards the inner profile 2 by means of the material of the ball guide 6. The return guide 14 is open outwardly towards the outer sleeve 5. The balls 4 are held in the return guide 14 outwardly towards the outer sleeve 5. For this purpose, an overhang 24 projects above the outside of the return guide 14 which overhang reduces the free cross section of the return guide 14 in such a way that the distance A1 is reduced to a distance A3. The distance A3 is smaller than the diameter of each of the balls 4 of the row 11. Alternatively, the return guide 14 is open inwards and outwards in a slot-like manner and/or the deviations 16 have a groove-shaped design in a similar way to the return guide 14.

The outer sleeve 5 of the bearing 1 according to FIGS. 1 and 2, which consist of sheet metal, is seated fixedly in the outer profile 3 and between the outer profile 3 and the balls 4. The outer sleeve 5:, illustrated as an individual part in FIG. 3, has the cross section of a polygonal hollow profile with preferably an even number of sides 5a. Each of the four sides 5a of the outer sleeve 5 has an inwardly facing side face 5b, of which in each case two are located opposite one another, with the inner profile 2 between them. Each of the side faces 5b is assigned two of the orbital ball raceways 10. The orbital ball raceways 10 on a side 5a are arranged next to one another in one plane transversely to the longitudinal axis 1a. In this case, the return guides 14 are directly adjacent to one another. On each of the side faces 5b, the metal sheet of the outer sleeve 5 is set back longitudinally and transversely above the deviations of the two orbital ball raceways 10 from the inside outwards, above the return guide 14 and at least partially above the deviations 16, in such a way that the non-loaded subsets 15 and 17 are arranged so as to be moveable transversely to the longitudinal axis la outwards in relation to the outer sleeve 5 by the amount of the movement play X (FIG. 1 and FIG. 7a).

The inner sleeve 7 consisting of sheet metal surrounds the inner profile 2 circumferentially and is arranged fixedly between the inner profile 2 and the balls 4 and relative to the inner profile 2. In this case, the inner sleeve 7 has a cross section of a polygonally designed hollow profile with preferably an even number of outwardly directed side faces 7a, in each case one of the sides 5 a of the outer sleeve 5 being located opposite the outwardly directed side faces 7a on the outside.

In the bearing 1, the bearing play directed transversely with respect to the longitudinal axis la is compensated elastically by means of the resiliently elastic elements 8. Each of the loaded subsets 13 in each of the longitudinal guides 12 is prestressed from the inside outwards against one of the sides 5 a of the outer sleeve 5 at least in each case by means of at least one of the elements 8 sprung elastically at least by the amount of half the bearing play. The resiliently elastic elements 8 are spring plates 20 produced in one part with the inner sleeve 7 and consisting of the sheet metal of the inner sleeve 7. In each case one of the spring plates 20 is prestressed against at least one subset 13 of the row 11 of one of the longitudinal guides 12 by the amount of a prestressing dimension corresponding at least to half the bearing play. Two of the spring plates 20 emanate from each outwardly directed side face 7a of the inner sleeve and in each case prestress one of the loaded subsets 13 against the outer sleeve 5, so that the inner profile 2 and the outer profile 3 are supported, free of play, relative to one another.

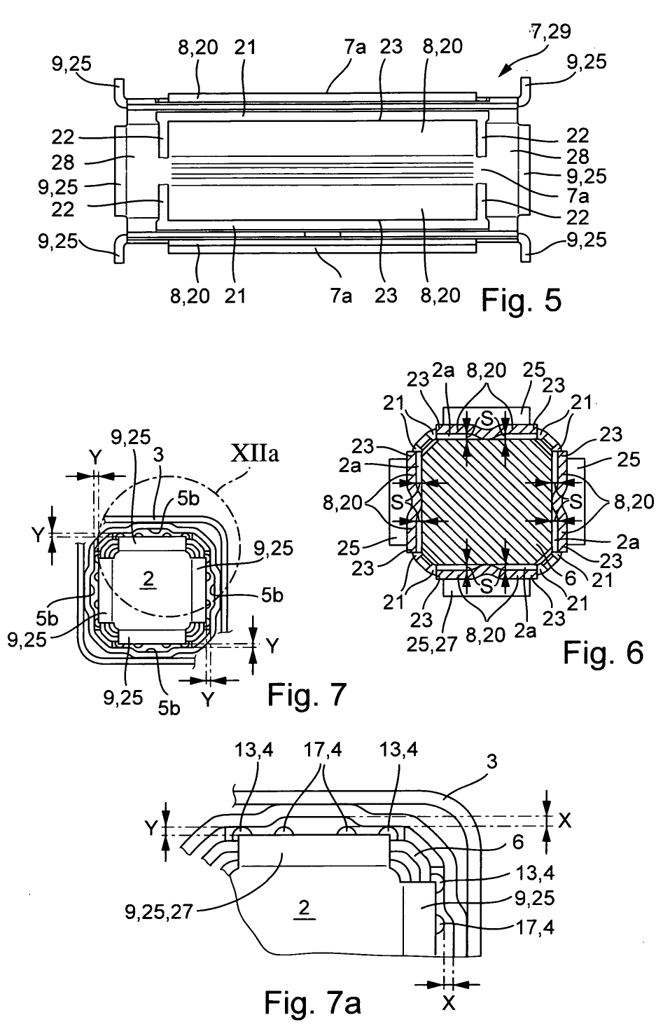

FIG. 5 illustrates the inner sleeve 7 as an individual part and FIG. 6 illustrates the said inner sleeve on the inner profile 6. The inner sleeve 7 is provided, on each of the outwardly directed side faces 7a, with two longitudinal slots 21 codirectional with the longitudinal axis la. Each of the spring plates 20 extends in the form of a strip longitudinally along one of the longitudinal slots 21. Furthermore, the inner sleeve 7 has cross slots 22 which run transversely with respect to the longitudinal axis la and which issue at right angles into the longitudinal slot 21. The spring plate 20 is separated, between the cross slots 22 and at its free end 23, from the inner sleeve 7 by the longitudinal slot 21, first runs in a bent form and then, further along, runs, stretched out, away from the inner sleeve 7 in a lever-like manner. The bent run of the spring plate 20 ensures that the spring plate 20 projects in the direction of the outer profile 5 and a gap dimension S is formed between the spring plate 20 and the inner profile 6 (FIG. 6). The gap dimension S ensures that, during the mounting of the bearing 1 and in the event of loads on the bearing 1 during driving, the spring plate 20 can be deflected elastically in the direction of the inner profile 6.

The overload safeguard 9 ensures that the profiles 2, 3 or sleeves 29 moved relative to one another transversely with respect to the longitudinal axis 1a and supported transversely with respect to the longitudinal axis 1a on the safeguard 9 do no damage the resiliently elastic elements 8 after the operating play Y has been overcome (FIGS. 7 and 7a). The safeguard 9 of the bearing 1 is a support 25 or 27 which adjoins the ball guide 6 longitudinally and is separate from the ball guide 6 and which is directed transversely with respect to the longitudinal axis 1a of the bearing 1. The support 25 or 27 is produced in one part with the inner sleeve 7. Four sheet-metal strips on each of the longitudinal sides 26 and 28 of the inner sleeve 7 are angled as supports 25 and 27 in the direction of the outer profile 3 and, on the support 27, are additionally folded back through 180°. The sheet-metal strips 27 hold the ball guide 6 longitudinally between them. As may be gathered from FIG. 4, the ball guide 6 together with balls and the inner sleeve 7 are preassembled to form a structural unit 28 before mounting in the outer sleeve 5.

FIGS. 8 to 14 show a further exemplary embodiment of the invention. A bearing 30 is illustrated in various views and details. The bearing 30 is formed from a sleeve 29 in the form of an outer sleeve 31, from the ball guide 6 and from a perforated disc 32.

The outer sleeve 31 of the bearing 30, consisting of sheet metal, is seated fixedly in the outer profile 3 and between the outer profile 3 and the balls 4. In the bearing 30, the bearing play directed transversely with respect to the longitudinal axis 30a is compensated elastically by means of the resiliently elastic elements 8. Each of the loaded subsets 13 in each of the longitudinal guides 12 is prestressed from the outside inwards, against a loaded subset 13 bearing on one of the sides 2a of the inner profile 2, at least in each case by means of at least one of the elements 8 which is sprung elastically at least by the amount of half the bearing play. The resiliently elastic elements 8 are spring plates 33 produced in one part with the outer sleeve 31 from sheet metal. The spring plates 33 cover the longitudinal guides 12 longitudinally and transversely from outside. The outer sleeve 31 has the cross section of a polygonal hollow profile with preferably an even number of sides 31a located opposite one another in pairs. Each of the four sides 31a of the outer sleeve 31 has an inwardly facing side face 31b, of which in each case two are located opposite one another, with the inner profile 2 between them. Two of the orbital ball raceways 10 are assigned to each of the side faces 31b. The orbital ball raceways 10 on a side 31 a are arranged next to one another in one plane transversely with respect to the longitudinal axis 30a. In this case, the return guides 14 are directly adjacent to one another. Each of in each case two mutually opposite sides 31 a has, with the inner profile 2 between them transversely with respect to the longitudinal axis, in each case two of the spring plates 33.

As illustrated in FIG. 8 and FIG. 11, the outer sleeve 31 is provided, on each of the mutually opposite sides 31a, with two longitudinal slots 34 codirectional with the longitudinal axis. In each case one of the spring plates 33 extends in the form of a strip longitudinally along one of the longitudinal slots 34. Moreover, the outer sleeve 31 has cross slots 35 running transversely with respect to the longitudinal direction and at right angles to the longitudinal slot 34 and merging into the longitudinal slot 34. The spring plate 33 initially runs in bent form along the cross slot 35 and subsequently projects from the outer sleeve 31 in a lever-like manner. The bent run of the spring plate 33 ensures that the spring plate 33 projects inwards into the outer sleeve 31 and a gap dimension S is formed between the spring plate 33 and the outer profile 3. The gap dimension S ensures that, during the mounting of the bearing 30 and in the event of loads on the bearing 30 during driving, the spring plate 33 can be deflected elastically in the direction of the outer profile 3.

Each of the spring plates 33 partially spans the deviations 16 of one of the two orbital ball raceways 10 assigned in each case to one of the sides 31a. In this case, the spring plate 33, at the ends 33a pointing in the longitudinal direction, is set back away from non-loaded balls 4 outwards in the direction of the outer profile 3 to an extent such that the non-loaded balls 4 are arranged so as to be moveable transversely with respect to the longitudinal direction outwards between the inner profile 2 and the ends 33a by the amount of an increasing movement play X′ (detail Z in FIG. 11 and FIG. 12).

On each of the sides 31a, the metal sheet of the outer sleeve 31 is set back outwards longitudinally and transversely, above the deviations 16 and above the return guides 14 of two mutually adjacent orbital ball raceways 10, by means of a shaped-out portion 36, in such a way that the balls 4 of the non-loaded subsets 15, 17 are arranged so as to be moveable transversely with respect to the longitudinal direction between the inner profile and the shaped-out portion 36 at least by the amount of the movement play X.

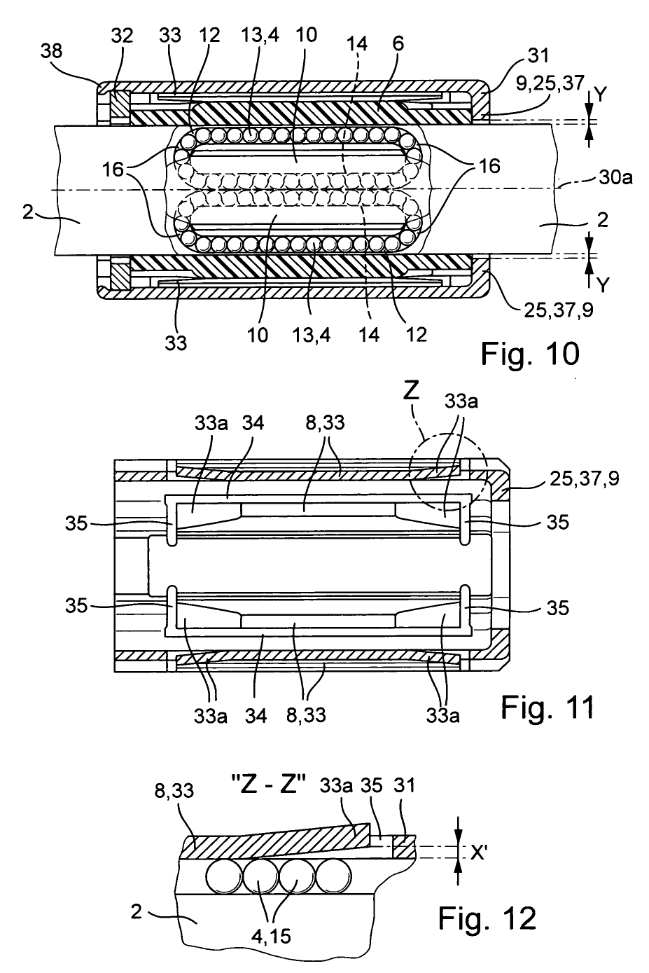

The support 25 is a rim 37, formed in one part with the outer sleeve 31 from the metal sheet of the outer sleeve 31, on one longitudinal side of the outer sleeve 31, or the support is the perforated disc 32 on the other longitudinal side. The rim 35 is formed peripherally on the outer sleeve 31 and points in the direction of the inner profile 2. The rim 37 is spaced apart from the inner profile 2, at least by the amount of the operating play Y with respect to the inner profile 2, in all directions transversely with respect to the longitudinal axis 30a of the bearing 30 (FIG. 10). The overload safeguard 9 in the form of the rim 35 ensures that the profiles 2, 3 or sleeves 29 moved relative to one another transversely with respect to the longitudinal axis 30a and supported on the safeguard 9 transversely with respect to the longitudinal axis 30a do not damage the resiliently elastic elements 8 after the operating play Y has been overcome.

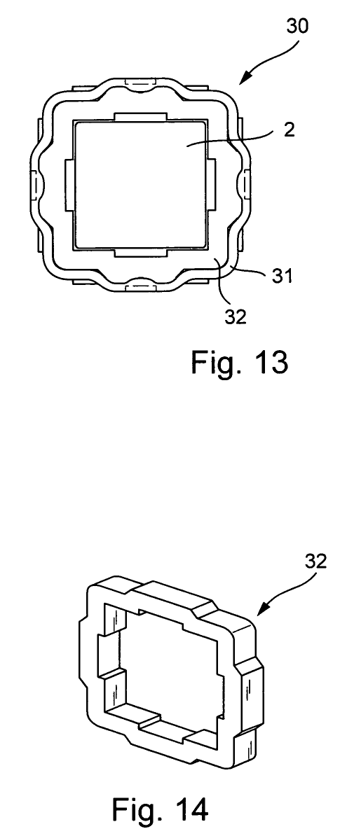

The perforated disc 32 is illustrated individually in FIG. 14 and as being built in the bearing 30 in FIG. 13 and is adapted on the inside and on the outside essentially to the cross sections of the inner profile 2 and of the outer sleeve 31 respectively. The ball guide 6 is fastened in the outer sleeve 31. For this purpose, the ball guide is held on one longitudinal side of the outer sleeve 31 by means of the rim 37 and on the other longitudinal side by means of the perforated disc 32. The perforated disc 32 is rolled fixedly into the outer sleeve 31 by means of a crimped edge 38 (FIG. 10).

Reference symbols

| | |
|---|---|
| 1 | Bearing |
| 1a | Longitudinal axis |
| 2 | Inner profile |
| 2a | Side |
| 3 | Outer profile |
| 4 | Ball |
| 5 | Outer sleeve |
| 5a | Side |
| 5b | Side face |
| 6 | Ball guide |
| 7 | Inner sleeve |
| 7a | Side face |
| 8 | Resiliently elastic element |
| 9 | Safeguard |
| 10 | Orbital ball raceway |
| 11 | Row |
| 12 | Longitudinal guide |
| 13 | Loaded subset |
| 14 | Return guide |
| 15 | First non-loaded subset |
| 16 | Deviation |
| 17 | Second non-loaded subset |
| 18 | Edge |
| 19 | Edge |
| 20 | Spring plate |
| 21 | Longitudinal slot |
| 22 | Cross slot |
| 23 | End |
| 24 | Overhand |
| 25 | Support |
| 26 | Longitudinal side |
| 27 | Support |
| 28 | Longitudinal side |
| 29 | Sleeve |
| 30 | Bearing |
| 30a | Longitudinal axis |
| 31 | Outer sleeve |
| 31a | Side |
| 31b | Side face |
| 32 | Perforated disc |
| 33 | Spring plate |
| 33a | End |
| 34 | Longitudinal slot |
| 35 | Cross slot |
| 36 | Shaped-out portion |
| 37 | Rim |
| 38 | Crimped edge |

1. Bearing (1, 30) for the longitudinally moving mounting of an inner profile (2) and of an outer profile (3) on one another, the inner profile (2) and the outer profile (3) being moveable relative to one another along a longitudinal axis (1a, 30a) of the bearing (1, 30), and the bearing (1, 30) transmitting torques between the inner profile (2) and the outer profile (3), the bearing (1, 30) being with
a sheet-metal outer sleeve (5, 31) arranged on the inside in the outer profile (3) and between the outer profile (3) and balls (4) and fixed with respect to the outer profile (3),
at least one ball guide (6) having orbital ball raceways (10),
resiliently elastic elements (8) for the compensation of bearing plays, and
an overload safeguard (9) arranged between the outer profile (3) and the inner profile (2),
and, at the same time, each of the orbital ball raceways (10) consisting of
a row (11) of balls (4),
a longitudinal guide (12) with a loaded subset (13) of the balls (4) of the row (11),
a return guide (14) with a first non-loaded subset (15) of balls (4) of the row (11), and
two deviations (16) connecting the longitudinal guide (12) to the return guide (14), the deviations (16) in each case having a second non-loaded subset (17) of balls (4) of the row (11), the bearing play directed transversely with respect to the longitudinal axis (1a, 30a) being compensated elastically in the bearing (1, 30), and, in this case, each of the loaded subsets (13) being loaded in each case by means of at least one of the elements (8) which is sprung elastically at least by the amount of half the bearing play, with the result that the inner profile (2) and the outer profile (3) are prestressed relative to one another, free of the bearing play, by means of the bearing (1, 30), and, in this case, the profiles (2, 3) moved relative to one another transversely with respect to the longitudinal axis (1a, 30a) and supported transversely with respect to the longitudinal axis (1a, 30a) on the resiliently elastic elements (8) being freely moveable with respect to one another, at least by the amount of an operating play, at the narrowest point between the outer profile (3) and the inner profile (2), and the inner profile (2) and the outer profile (3) being supported relative to one another at the overload safeguard (9) after the operating play has been overcome, wherein the ball guide (6) is produced in one part with at least one orbital ball raceway (10), the ball guide (6) being arranged on the inside in the outer profile (3) between the outer sleeve (5, 31) and the inner profile (2), and in that the safeguard (9) is in each case at least one support (25, 27) which adjoins the ball guide (6) longitudinally and is separate from the ball guide (6) and which is directed transversely with respect to the longitudinal axis (1a, 30a) of the bearing (1, 30).

2. A bearing of claim 1, wherein the outer sleeve (5, 31) has the cross section of a polygonal hollow profile with an even number of sides (5a, 31a).

3. A bearing of claim 2, wherein the support (25) is formed in one part with the outer sleeve (31) from the metal sheet of the outer sleeve (31).

4. A bearing of claim 3, wherein the support (25) is at least one rim (37) emanating from the outer sleeve (31) in the direction of the profile (2).

5. A bearing of claim 4, wherein, on a non-loaded bearing (30), the rim (35) is spaced apart from the inner profile (2) at least by the amount of the operating play in all directions transversely with respect to the longitudinal axis (30a).

6. A bearing of claim 1, wherein the support (25) is a perforated disc (32), the perforated disc (32) surrounding the inner profile (2) on the outside, and the perforated disc (32) being surrounded on the outside by the outer sleeve (31).

7. A bearing of claim 6, wherein the perforated disc (32) is fastened in the outer sleeve (31), and in that, on the non-loaded bearing (30), the perforated disc (32) is spaced apart from the inner profile (2) at least by the amount of the operating play in all directions transversely with respect to the longitudinal axis (30a).

8. A bearing of claim 2, wherein in each case at least one of the orbital ball raceways (10) is assigned in each case to an inwardly facing side face (5b, 31b) in each case on one of four of the sides (5a, 31a) of the outer sleeve (5, 31), in each case two of the side faces (5b, 31b) being located opposite one another, with the inner profile (2) between them.

9. A bearing of claim 8, wherein, in each case, two of the orbital ball raceways (10) are assigned to each of the side faces (5b, 31b).

10. A bearing of claim 8 or 9, wherein the bearing (1, 30) has a one-part ball guide (6), the orbital ball raceways (10) being formed in the ball guide (6).

11. A bearing of claim 1, wherein the balls (4) of the row (11) are held in the orbital ball raceway (10) inwardly in the direction of the inner profile (2) and outwardly in the direction of the outer profile (3) by means of the material of the ball guide (6).

12. A bearing of claim 1, wherein the longitudinal guide (12) is of slot-like design, the longitudinal guide (12) piercing the ball guide (6) transversely with respect to the longitudinal axis (1a, 30a) from the inside from the direction of the inner profile (2) outwards in the direction of the outer profile (3) and, as seen in the cross section of the bearing (1, 30), being delimited laterally by the material of the ball guide (6), and, in the longitudinal guide (12), a greatest free distance between the material of the ball guide (6) transversely with respect to the longitudinal axis (1a, 30 a) corresponding at least to the ball diameter of the largest ball (4) in the orbital ball raceway (10).

13. A bearing of claim 12, wherein the balls (4) of the loaded subset (13) are held in the longitudinal guide (12) inwardly at mutually opposite edges (18) of the longitudinal guide (12) and outwardly at mutually opposite edges (19) of the longitudinal guide.

14. A bearing of claim 12 or 13, wherein the balls (4) of the loaded subset (13) project from the longitudinal guide (12), beyond the ball guide (6), inwards in the direction of the inner profile (2) and outwards in the direction of the outer sleeve (3), at least at the longitudinal guide (12), the balls (4) of the loaded subset (13) bearing against the outer sleeve (3).

15. A bearing of claim 1, wherein the deviation (16) runs at least partially arcuately and has at least proportionately a slot-like design, the deviation (16) of slot-like design being open inwardly towards the inner profile (2) and outwardly towards the outer profile (3), and in that the balls (4) of the second non-loaded subset (17) of each of the deviations (16) are held in the deviation inwardly towards the inner profile (2) and outwardly towards the outer profile (3).

16. A bearing of claim 15, wherein the balls (4) in the deviations (16) are moveable in relation to the outer sleeve (5, 31) from the inside outwards transversely with respect to the longitudinal axis (1a, 30a).

17. A bearing of claim 16, wherein the balls (4) in the deviations (16) are moveable in relation to the outer sleeve (5) from the inside outwards transversely with respect to the longitudinal axis (1a, 30a) at least by the amount of the operating play.

18. A bearing of claim 1, wherein the return guide (14) is of groove-shaped design and runs parallel to the longitudinal guide (12), the return guide (14) being closed off inwardly towards the inner profile by means of the material of the ball guide, and the return guide (14) being open outwards towards the outer profile (3), and in that the balls (4) in the return guide (12) are held in the return guide (12) outwardly towards the outer profile (3), the balls (4) of the first non-loaded subset (15) in the return guide (14) being moveable in relation to the outer sleeve from the inside outwards transversely with respect to the longitudinal axis (1a, 30a).

19. A bearing of claim 18, wherein the balls (4) are moveable in relation to the outer sleeve (5, 31) from the inside outwards transversely with respect to the longitudinal axis (1a, 30a) at least by the amount of the operating play (16).

20. A bearing of claim 2, wherein the loaded subsets (13) in each of the orbital ball raceways (10) are loaded in each case at least by means of one of the resiliently elastic elements (8) which runs above the longitudinal guide (12) in the longitudinal direction and which is prestressed inwards against the balls (4), and, during longitudinal movements of the profiles (2, 3) relative to one another, the balls (4) of the loaded subsets (13) run longitudinally on the resiliently elastic elements (8) codirectionally with the longitudinal axis.

21. A bearing of claim 20, wherein the resiliently elastic elements (8) are spring plates (33) produced in one part with the outer sleeve (31) and consisting of the sheet metal of the outer sleeve (31), in each case one of the spring plates (33) being prestressed against at least one loaded subset (13) of balls (4) of the row (11) in one of the longitudinal guides (12) by the amount of a prestressing dimension corresponding at least to half the bearing play, and the spring plate (33) in this case prestressing the balls (4) against the inner profile (2), and each of the mutually opposite sides faces (31b) of the outer sleeve (31) having at least one of the spring plates (33), with the result that the inner profile (2) and the outer profile (3) are prestressed, free of play, relative to one another.

22. A bearing of claim 21, wherein the outer sleeve (33) is provided, on each of the mutually opposite sides (33a), with at least one longitudinal slot (34) codirectional with the longitudinal axis (30a), the spring plate (33) extending in the form of a strip longitudinally along the longitudinal slot (34), and in that the outer sleeve (33) has cross slots (35) running transversely with respect to the longitudinal direction and at right angles to the longitudinal slot (34) and merging into the longitudinal slot (34), the spring plate (33) projecting from the outer sleeve (33) at least transversely in a lever-like manner between the cross slots (35).

23. A bearing of claim 22, wherein the spring plate (33) is prestressed at least partially inwards into the outer sleeve (31), each of the spring plates (33) spanning at least one of the subsets (13) of the longitudinal guides (12) on the outside transversely with respect to the longitudinal axis (30a), as seen in the cross section through the bearing (30).

24. A bearing of claim 2, wherein the metal sheet of the outer sleeve (5, 31) is set back from the inside outwards away from the second non-loaded subsets (17) longitudinally and transversely above the deviations (16), so that the balls (4) of the second non-loaded subsets (17) are arranged so as to be moveable relative to the outer sleeve (5, 31) from the inside outwards transversely with respect to the longitudinal axis (1a, 30a).

25. A bearing of claim 24, wherein the balls (4) of the second non-loaded subsets (17) are arranged so as to be moveable relative to the outer sleeve (5, 31) from the inside outwards transversely with respect to the longitudinal axis (1a, 30a) at least by the amount of the operating play.

26. A bearing of claim 2, wherein the resiliently elastic elements (8) are spring plates (33) produced in one part with the outer sleeve (31) and consisting of the sheet metal of the outer sleeve (31), in each case one of the spring plates (33) being prestressed against at least one of the loaded subsets (13) by the amount of a prestressing dimension corresponding at least to half the bearing play, and, in this case, prestressing the balls (4) against the inner profile (2), and each of the mutually opposite sides (31a) of the outer sleeve (31) having at least one of the spring plates (33), and in that each of the spring plates (330 at least partially spans the deviations (16) of one of the orbital raceways (10) and, in this case, is set back outwards away from the balls (4) of the second non-loaded subsets (17) to an extent such that the balls (4) are arranged so as to be moveable relative to the spring plates (33) from the inside outwards transversely with respect to the longitudinal axis (30a).

27. A bearing of claim 2, wherein the metal sheet of the outer sleeve (5, 31) is set back away from the first non-loaded subset (15) from the inside outwards longitudinally and transversely above the return guide (14), so that the balls (4) of the first non-loaded subset (15) are arranged so as to be moveable relative to the outer sleeve (5, 31) from the inside outwards transversely with respect to the longitudinal axis (1a, 30a).

28. A bearing of claim 27, wherein the first non-loaded subset (15) of balls (4) is arranged so as to be moveable relative to the outer sleeve (5, 31) from the inside outwards transversely with respect to the longitudinal axis (1a, 30a) at least by the amount of the operating play.

29. A bearing of claim 2, wherein the bearing (1) has a sheet-metal inner sleeve (7) surrounding the inner profile (2) circumferentially and arranged between the inner profile (2) and the balls (4), the inner sleeve (7) being arranged fixedly in relation to the inner profile (2).

30. A bearing of claim 29, wherein the inner sleeve (7) has the cross section of a polygonally designed hollow profile with preferably an even number of outwardly directed side faces (7a), in each case one of the sides (5a) of the outer profile (5) being located opposite the outwardly directed side faces (7a) of the inner sleeve (7) on the outside.

31. A bearing of claim 30, wherein the support (25, 27) is formed in one part with the inner sleeve (7) from the metal sheet of the inner sleeve (7).

32. A bearing of claim 31, wherein the support (25, 27) is angled outwards in each case from the metal sheet of the inner sleeve (7) and emanates from the outwardly directed side face (7a).

33. A bearing of claim 31, wherein, on the non-loaded bearing (1) the support (25, 27) is spaced apart from the outer sleeve (5), at least by the amount of the operating play, from the inside outwards transversely with respect to the longitudinal axis (1a).

34. A bearing of claim 29, wherein the subset (13), loaded in the longitudinal guide (12), of each of the orbital ball raceways (10) is loaded by means of at least one of the resiliently elastic elements (8) which is prestressed against the balls (4) from the inside, the balls (4) of the loaded subset (13) rolling on the spring element (8) longitudinally relative to the longitudinal axis (1a) during longitudinal movements of the profiles (2, 3).

35. A bearing of claim 29, wherein the resiliently elastic elements (8) are spring plates (20) produced in one part with the inner sleeve (7) and consisting of the sheet metal of the inner sleeve (7), in each case one of the spring plates (20) being prestressed against at least one loaded subset (13) of one of the longitudinal guides (12) by the amount of a prestressing dimension corresponding at least to half the bearing play and, in this case, prestressing the balls (4) against the outer sleeve (5), and at least one of the spring plates (20) emanating from each of the outwardly directed side faces (7a), with the result that the inner profile (2) and the outer profile (3) are prestressed, free of play, relative to one another.

36. A bearing of claim 30, wherein the inner sleeve (7) is provided, on each of the outwardly directed side faces (7a), with at least one longitudinal slot (21) codirectional with the longitudinal axis (1a), the spring plate (20) extending in the form of a strip longitudinally along the longitudinal slot (21), and in that the inner sleeve (7) has cross slots (22) running transversely with respect to the longitudinal direction and at right angles to the longitudinal slot (21) and merging into the longitudinal slot (21), the spring plate (20) projecting from the inner sleeve (7) in a lever-like manner at least transversely with respect to the longitudinal axis (1a) between the cross slots (22).

37. A bearing of claim 1, wherein the resiliently elastic elements (8) are spring plates (20, 33) produced in one part with a sheet-metal sleeve surrounding the inner profile (2) circumferentially and at the same time spanning the longitudinal guides (12) longitudinally and transversely with respect to the longitudinal axis (1a, 30a), the sleeve (29) having the cross section of a polygonal hollow profile with preferably an even number of sides (5a, 31a) located opposite one another in pairs, and in each case with a spring plate (20, 33) being prestressed against at least one loaded subset (13) of balls (4) of the row (11) of one of the longitudinal guides (12) by the amount of a prestressing dimension corresponding at least to half the bearing play, and, during longitudinal movements of the profiles (2, 3) relative to one another, the balls (4) of the loaded subset (13) in this case rolling on the spring element (8) longitudinally with respect to the longitudinal axis (1a), and in that each of the mutually opposite sides (5a, 31a) of the sleeve (29) has, with the inner profile (2) being between them transversely with respect to the longitudinal axis (1a), at least one of the spring plates (20, 33).

38. A bearing of claim 37, wherein the sleeve (29) is provided, on each of the mutually opposite sides (5a, 31a), with at least one longitudinal slot (21, 34) codirectional with the longitudinal axis (1a, 30a), the spring plate (20, 33) extending in the form of a strip longitudinally along the longitudinal slot (21, 34), and in that the sleeve (29) has cross slots (22, 35) running transversely with respect to the longitudinal direction and at right angles to the longitudinal slot (21, 34) and merging into the longitudinal slot (21, 34), the spring plate (20, 33) projecting from the sleeve (29) transversely in a lever-like manner along the cross slot (22, 35).

39. A bearing of claim 38, wherein the sleeve (29) is the outer sleeve (31), the spring plates (33) formed on the outer sleeve (31) prestressing the balls (4) against the inner profile, and each of the mutually opposite sides (31a) of the outer sleeve (31) having t least one of the spring plates (33), with the result that the inner profile (2) and the outer profile (3) are prestressed, free of play, relative to one another.

40. A bearing of claim 39, wherein each of the spring plates (33) at least partially spans the deviations (16) of one of the orbital raceways (10) and in this case is set back outwards away from the second non-loaded subsets (17) to an extent such that the balls (4) of the second non-loaded subsets (17) are arranged so as to be moveable outwards relative to the spring plates (33) transversely with respect to the longitudinal axis (1a) by the amount of the movement play.

41. A bearing of claim 37, wherein the support (25) is formed in one part with the outer sleeve (31) from the metal sheet of the outer sleeve.

42. A bearing of claim 41, wherein the support (25) is at least one rim (37) emanating from the outer sleeve (31) in the direction of the inner profile.

43. A bearing of claim 42, wherein the rim (37) is spaced apart from the inner profile (2), at least by the amount of the operating play, in all directions transversely with respect to the longitudinal axis (30a).

44. A bearing of claim 38, wherein the metal sheet of the outer sleeve (5, 31) is set back, from the inside outwards, outwards away from the balls (4) of the non-loaded subsets (15, 17) of the row (11) longitudinally and transversely above the deviations (16) and above the return guide (14), so that the balls (4) of the non-loaded subsets (15, 17) are arranged so as to be moveable relative to the outer sleeve (5, 31) from the inside outwards in the deviation (16) transversely with respect to the longitudinal axis (1a, 30a).

45. A bearing of claim 44, wherein the balls (4) of the non-loaded subsets (15, 17) are arranged in the deviation (16) and the return guide (14) so as to be moveable relative to the outer sleeve (5, 31) from the inside outwards transversely with respect to the longitudinal axis (1a, 30a) at least by the amount of the operating play.

46. A bearing of claim 38, wherein each of the spring plates (20, 33) at least partially spans the deviations (16) of one of the orbital raceways (10) transversely and in this case is set back away from the balls (4) of the second non-loaded subsets (17) to an extent such that the balls (4) of the second non-loaded subsets (17) are arranged so as to be moveable relative to the spring plates (20, 33) transversely with respect to the longitudinal axis (1a, 30a) by the amount of the movement play.

47. A bearing of claim 37, wherein the sleeve (29) is a sheet-metal inner sleeve (27) surrounding the inner profile (2) circumferentially and arranged between the inner profile (2) and the balls (4), with the inner sleeve (7) being arranged fixedly in relation to the inner profile.

48. A bearing of claim 47, wherein the inner sleeve (7) has the cross section of a polygonally designed hollow profile with preferably an even number of outwardly directed side faces (7a), in each case an inwardly directed side face (5b) of the outer sleeve (5) being located opposite the outwardly directed side faces (7a) of the inner sleeve (7).

49. A bearing of claim 48, wherein the support (25, 27) is formed in one part with the inner sleeve (7) from the metal sheet of the inner sleeve (7).

50. A bearing of claim 49, wherein the support (25, 27) in each case emanates, angled outwards, from the metal sheet of the inner sleeve (7).

51. A bearing of claim 50, wherein, on the non-loaded bearing (1), the support (25, 27) is spaced apart from the outer sleeve (5) on the non-loaded bearing from the inside outwards transversely with respect to the longitudinal axis (1a) at least by the amount of the operating play.
